(19) United States
(12) Patent Application Publication
(10) Pub. No.: US 2024/0383632 A1
(43) Pub. Date: Nov. 21, 2024

(54) TROLLEY FOR SUPPORTING A LABELING STATION IN A LABELING MACHINE

(71) Applicant: P.E. LABELLERS S.P.A., Porto Mantovano (IT)

(72) Inventor: Luca BONARDI, San Giorgio Bigarello (IT)

(21) Appl. No.: 18/696,766

(22) PCT Filed: Sep. 21, 2022
(86) PCT No.: PCT/EP2022/076202

§ 371 Date: Mar. 28, 2024

(30) Foreign Application Priority Data
Sep. 30, 2021 (IT) 102021000025025

(51) Int. Cl. B65C 9/02; B62B 3/02

(52) U.S. Cl. CPC B65C 9/02; B62B 3/02; B62B 2206/06

(57) ABSTRACT

A trolley for supporting a labeling station in a labeling machine includes a housing which defines, in an upper region, a supporting surface for a labeling station and is provided, in a lower region, with wheels for resting on a floor, and at least one supporting element for at least two of the wheels and an adjustment device in order to adjustably vary a distance between the supporting element and the housing.

The present invention relates to a trolley for supporting a labeling station in a labeling machine.

Carousel labeling machines are known wherein labeling stations are provided which are supported by a respective trolley which is provided with wheels and is positioned in the immediate vicinity of the carousel in order to be fixed to the supporting structure of the carousel.

In some types of machine, the trolley is fixed while keeping the wheels in contact with the floor, with the consequence that imperfections in the floor can compromise the required precision in the positioning of the labeling station.

The aim of the present invention is to provide a trolley for supporting a labeling station in a labeling machine which is capable of improving the known art in one or more of the above mentioned aspects.

Within this aim, an object of the invention is to provide a trolley for supporting a labeling station in a labeling machine that can ensure the precision of its positioning on the machine, even in the presence of imperfections in the floor, in a very simple manner.

Another object of the invention is to provide a trolley for supporting a labeling station in a labeling machine that is easy and convenient in use for the operators.

A further object of the present invention is to overcome the drawbacks of the background art in a manner that is alternative to any existing solutions.

Another object of the invention is to provide a trolley for supporting a labeling station in a labeling machine that is highly reliable, is relatively easy to implement, and can be produced at low cost.

This aim and these and other objects which will become better apparent hereinafter are achieved by a trolley for supporting a labeling station in a labeling machine according to claim 1, optionally provided with one or more of the characteristics of the dependent claims.

Further characteristics and advantages of the invention will become better apparent from the detailed description that follows of a preferred, but not exclusive, embodiment of the trolley for supporting a labeling station in a labeling machine according to the invention, which is illustrated by way of non-limiting example in the accompanying drawings, wherein:

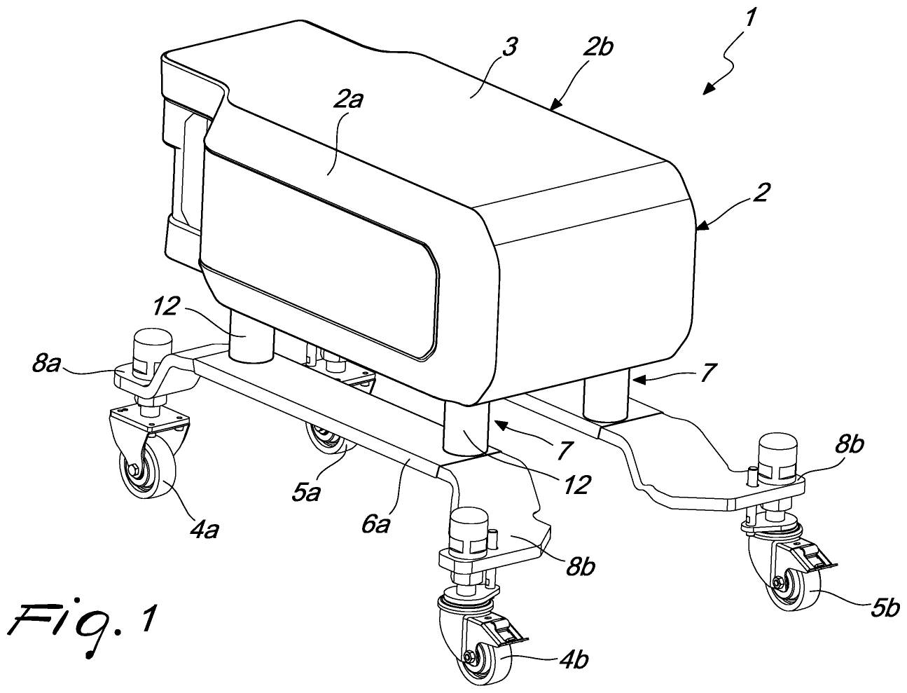

FIG. 1 is a perspective view of the trolley according to the invention;

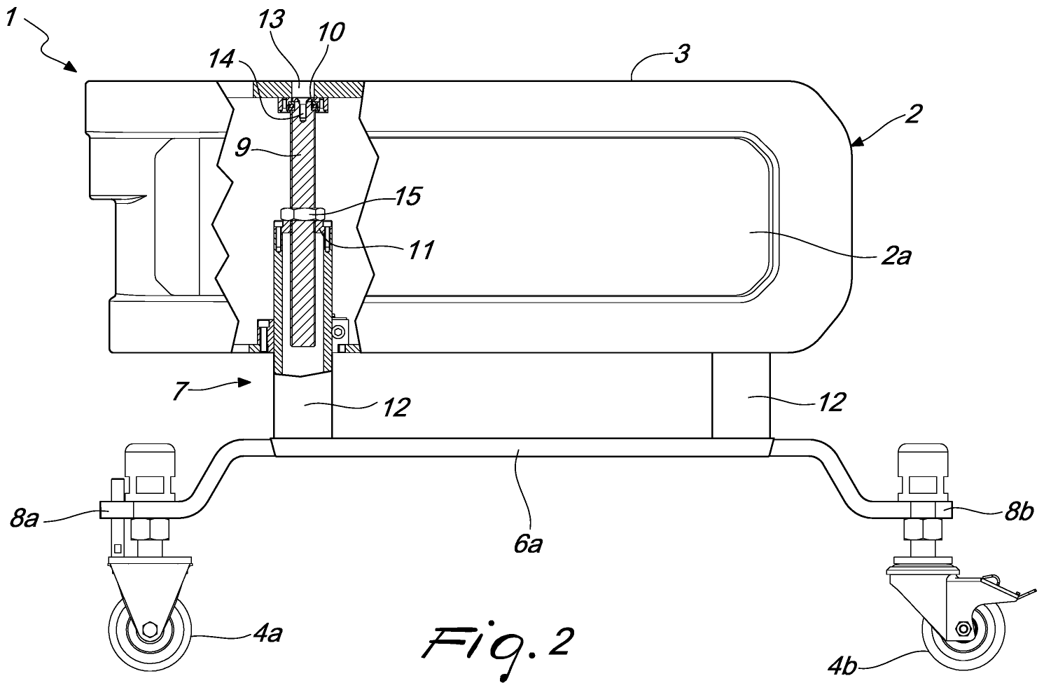

FIG. 2 is a partial cross-sectional side view of the trolley according to the invention;

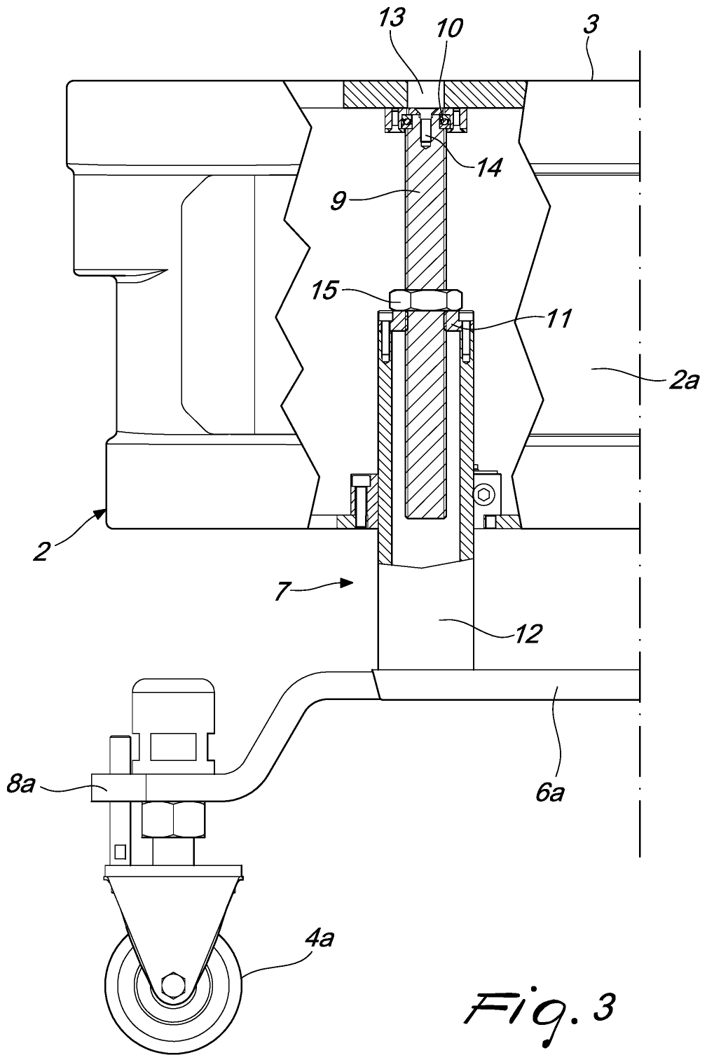

FIG. 3 is an enlarged-scale view of a detail of FIG. 1;

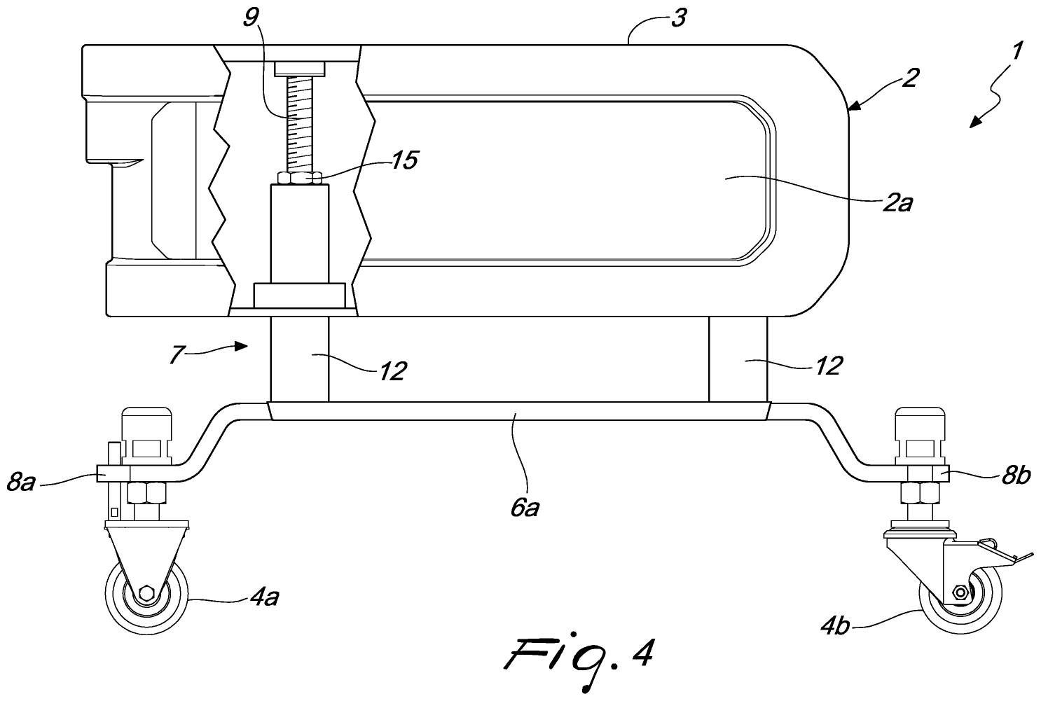

FIG. 4 is a partially cutaway side view of the trolley according to the invention.

With reference to the figures, the trolley for supporting a labeling station in a labeling machine according to the invention, generally designated by the reference numeral 1, comprises a housing 2, which constitutes in practice the main body of the trolley and which defines, in an upper region, a supporting surface 3 for a labeling station, not shown.

The housing 2 has two mutually opposite side walls 2a, 2b which extend along the longitudinal axis of the housing 2.

In a lower region, the trolley is provided with wheels 4a, 4b, 5a, 5b for resting on the floor, in order to allow it to be easily entrained. In particular, a first pair of wheels 4a and 4b are arranged substantially at or proximate to one of the two side walls of the housing 2, for example the side wall indicated with 2a, one at the front and the other at the rear, with respect to the longitudinal axis of the housing 2, while a second pair of wheels 5a and 5b is arranged substantially at or proximate to the other side wall 2b of the housing 2, again one at the front and the other at the rear, with respect to the longitudinal axis of the housing.

The trolley further comprises at least one supporting element 6a, 6b for at least two of the wheels 4a, 4b, 5a, 5b and adjustment means 7 in order to make it possible to vary the distance between this supporting element 6a, 6b and the housing 2, so as to be able to correct any incorrect positioning of the supporting surface 3 with respect to the carousel of the machine owing to imperfections in the floor.

Preferably, a pair of supporting elements 6a, 6b, each one of which supports a respective pair of the wheels 4a, 4b and 5a, 5b is provided, which is arranged along a corresponding side wall 2a, 2b of the housing 2. For example, the supporting element 6a supports the wheels 4a, 4b arranged along the wall 2a of the housing 2, while the other supporting element 6b supports the wheels 5a, 5b arranged along the wall 2b of the housing 2.

In this case, each one of the two supporting elements 6a, 6b is connected to the housing 2 by way of respective adjustment means 7 in order to allow an adjustment independent of the distance of the two supporting elements 6a, 6b with respect to the housing 2.

In this manner, it is possible to ensure a more precise positioning of the supporting surface 3, thus making it possible to correct the position of the supporting surface 3 even in the presence of height differences in the floor between the part of the floor that is under one of the two side walls 2a, 2b of the housing 2 and the part of the floor that is under the other side wall 2a, 2b of the housing 2.

Conveniently, each supporting element 6a, 6b presents a plate-like structure with an elongated extension, with two flat coupling portions 8a, 8b for the respective wheels 4a, 4b, 5a, 5b defined at the opposite ends and preferably arranged on the same side and spaced apart with respect to the plane of arrangement of the intermediate portion of the supporting elements 6a, 6b.

As illustrated, the adjustment means 7 comprise, for each supporting element 6a, 6b, at least one threaded pin 9, which has a substantially vertical axis and is supported so that it can rotate, for example by way of bearings 10, by the housing 2.

Each threaded pin 9, in turn, engages a corresponding female thread 11, which is integral with the corresponding supporting element 6a, 6b.

Conveniently, the female thread 11 of each threaded pin 9 is associated axially with a respective sleeve 12, which is fixed to the corresponding supporting element 6a, 6b and protrudes slideably from the housing 2.

Preferably, for each supporting element 6a, 6b, there is at least one pair of threaded pins 9 which are arranged mutually spaced apart along the longitudinal extension of the housing 2.

Conveniently, the threaded pins 9 are accommodated inside the housing 9 and are accessible from outside by way of at least one access opening 13, through which they can be maneuvered by the operator, in order to allow their screwing into or unscrewing out of the respective female thread 11, preferably using special tools that can be engaged in special maneuvering seats 14, which are defined in the threaded pins.

Optionally, the rotation of the threaded pins 9 can be actuated by way of drive means that can be activated on command by the operator.

It should be noted that the threading of the threaded pins 9 has a preset pitch, preferably of a few millimeters, and can, optionally, engage the corresponding female screw seats 11 with a certain amount of play. In this manner, for each supporting element 6a, 6b, the operator can act on one of the threaded pins 9 so as to obtain the displacement of the corresponding female thread 11, within the limits permitted by the threading pitch or by the existing play, along its axis for a short portion, for example a few millimeters, without needing to rotate the other threaded pin 9 at the same time.

Advantageously, for each threaded pin 9, at least one locking nut 15 is provided, which is screwed along the threaded pin 9 and which can be tightened against the mouth of the respective female thread 11.

The use of the trolley according to the invention is as follows.

The operator, once the trolley has been brought adjacent to the carousel of the machine, verifies the precision of the positioning of the supporting surface 3 with respect to the carousel.

If, owing to any imperfections in the floor, the operator detects an incorrect positioning of the supporting surface 3, he or she can proceed to make the threaded pins 9 of one of the supporting elements 6a, 6b rotate, after unscrewing the corresponding locking nut 15 and removing it from the corresponding female thread 11, so as to vary the distance of the corresponding supporting element 6a, 6b from the housing 2.

If necessary, the operator proceeds similarly for the other supporting element 6a, 6b by acting on the corresponding threaded pins 9.

Within the limitations of the pitch or play permitted by the threading, it is optionally possible, for each supporting element 6a, 6b, to act on one of the threaded pins 9 so as to vary the position of the corresponding female thread 11 and therefore of the wheel 4a, 4b, 5a, 5b that is closest to it, without also maneuvering the other threaded pin 9.

In practice it has been found that the invention fully achieves the intended aim and objects by providing a trolley for supporting a labeling station in a labeling machine that makes it possible to easily overcome errors in the positioning of its supporting surface for the labeling station in the event of imperfections in the floor.

The invention thus conceived is susceptible of numerous modifications and variations, all of which are within the scope of the appended claims. Moreover, all the details may be substituted by other, technically equivalent elements.

In practice, the materials used, as well as the contingent shapes and dimensions, may be any according to the requirements and to the state of the art.

The disclosures in Italian Patent Application No. 102021000025025 from which this application claims priority are incorporated herein by reference.

Where technical features mentioned in any claim are followed by reference signs, those reference signs have been included for the sole purpose of increasing the intelligibility of the claims and accordingly, such reference signs do not have any limiting effect on the interpretation of each element identified by way of example by such reference signs.

1-5. (canceled)

6. A trolley for supporting a labeling station in a labeling machine,
comprising a housing which defines, in an upper region, a supporting surface for a labeling station and is provided, in a lower region, with wheels for resting on a floor, and further comprising at least one supporting element for at least two of said wheels and adjustment means in order to adjustably vary a distance between said at least one supporting element and said housing.

7. The trolley according to claim 6, further comprising a pair of supporting elements, each one supporting a respective pair of said wheels which is arranged along a corresponding side wall of said housing, each one of said supporting elements being connected to said housing by way of respective adjustment means in order to allow an independent adjustment of the distance of said supporting elements from said housing.

8. The trolley according to claim 7, wherein said respective adjustment means comprise, for each of said pair of supporting element, at least one threaded pin, which has a substantially vertical axis, is supported rotatably by said housing, and engages a respective female thread which is integral with the respective supporting element.

9. The trolley according to claim 7, further comprising, for each one of said supporting elements, at least one pair of threaded pins which are mutually spaced apart along a longitudinal extension of said housing.

10. The trolley according to claim 9, further comprising, for each of said pair of threaded pins, at least one locking nut, which engages the mouth of the respective female thread.
